(19) United States
(12) Patent Application Publication
(10) Pub. No.: US 2011/0269635 A1
(43) Pub. Date: Nov. 3, 2011

(54) SYSTEMS AND METHODS FOR HIGH-THROUGHPUT SCREENING USING LIGHT SCATTERING

(75) Inventor: Daniel I. Some, Santa Barbara, CA (US)

(73) Assignee: WYATT TECHNOLOGY CORPORATION, Santa Barbara, CA (US)

(21) Appl. No.: 12/770,496

(22) Filed: Apr. 29, 2010

(51) Int. Cl. C40B 30/04

(52) U.S. Cl. 506/9

(57) ABSTRACT

Systems and methods for high-throughput screening can be used to determine whether binding occurs between different molecular species. Some systems compare measurements obtained from a static light scattering detector relative to a first solution that includes a target molecular species, a second solution that includes a test molecular species, and a third solution that includes a mixture of the target and test molecular species.

### TECHNICAL FIELD

The present disclosure relates to systems and methods that use light scattering in analyzing molecular binding.

### BRIEF DESCRIPTION OF THE DRAWINGS

The written disclosure describes illustrative embodiments that are non-limiting and non-exhaustive. Reference is made to certain of such illustrative embodiments that are depicted in the figures, in which:

FIG. 1 is a schematic diagram of an embodiment of a high-throughput screening system that employs light scattering;

FIG. 2 is a schematic partial plan view of an embodiment of a microwell plate containing a screening library that may be used with the system of FIG. 1;

FIG. 3A is a depiction of a graph that may be obtained via the system of FIG. 1, which depicts the light scattering intensity detected by a static light scattering detector as a function of time, and which illustrates signals obtained from separate solutions of a target molecular species X, a test molecular species Y, and a mixture of the target and test molecular species X, Y and associated complexes thereof;

FIG. 3B is a depiction of another graph that may be obtained via the system of FIG. 1, which depicts the light scattering intensity detected by a static light scattering detector as a function of time, and which illustrates signals obtained from separate solutions of a target molecular species X, a test molecular species Z, and a combination of the target and test molecular species X, Z in which the first and second molecular species X, Z generally do not bind with each other; and

FIG. 4 is schematic partial plan view of another embodiment of a microwell plate containing a screening library that may be used with the system of FIG. 1.

### DETAILED DESCRIPTION

The process of drug discovery, as applied by many pharmaceutical research laboratories, can include a stage in which the activity of a candidate molecule is tested against a large library of target molecules, often involving thousands or even millions of different targets. An activity assay may test for binding, such as whether an antibody binds to an antigen, or it may test for inhibition, such as whether a small molecule inhibits association of an enzyme and a substrate. Since a large number of target molecules may be screened for a given set of assays, it can be desirable to run the assays quickly using relatively small amounts of test materials. Such an approach is referred to herein as “high-throughput screening.”

Various known screening methods can suffer from a variety of drawbacks, some of which may render the screening methods undesirable or infeasible for high-throughput screening. Such screening methods can include, for example, biochemical assays and biophysical assays. Biochemical assays can employ biochemical indicators, which may behave quite differently depending on the molecules with which the biochemical indicators are used.

Although they generally do not depend on biochemical indicators, biophysical assays can suffer from other limitations. For example, some common biophysical assays, such as surface plasmon resonance (SPR), typically require that one molecule (e.g., a receptor) be immobilized on a testing surface, while another molecule (e.g., a ligand) be suspended in solution. In some instances, the molecule in solution may bind non-specifically to the testing surface, thereby creating a false positive in the case of an assay that is designed to test for specific binding between the molecule in solution and the immobilized molecule. In other biophysical assays, one or both of the molecular species may be labeled with radiological or fluorescent markers. Such labeling may be undesirable in some cases, as it may alter the interaction of the molecules that are being tested. This likewise can lead to false positives or false negatives in the screening assay.

A different assaying technique is known as composition gradient multi-angle static light scattering (CG-MALS). In this technique, a series of solutions that comprise the same constituent parts, but in differing amounts, are analyzed via static light scattering to determine binding affinity and stoichiometry of reversibly associating macromolecular complexes. A suitable system for carrying out CG-MALS measurements can include the Calypso™, which is available from Wyatt Technology Corporation of Santa Barbara, Calif. One potential advantage of CG-MALS over SPR and radiological or fluorescent assays is that it does not use labeling or require immobilization of one or more of the molecular species under examination. Rather, the molecular species under observation, such as, for example, both a receptor and a ligand, may be suspended in solution and may be free of labels. The results produced via CG-MALS thus may be more reliable, as compared with SPR- or marker-based assays.

However, CG-MALS measurements generally use large quantities of sample materials (e.g., several milliliters), which can be undesirable in the context of, for example, drug discovery. Likewise, CG-MALS measurement generally can take a relatively long period to complete (e.g., from about 30 to about 120 minutes), which may be unreasonable for high-throughput screening.

Another technique that can be used for characterizing macromolecular binding is known as size exclusion chromatography multi-angle static light scattering (SEC-MALS). In this technique, a solution containing bound complexes of various sizes is caused to flow through a column of packed beads. Due to their interaction with the beads, complexes of different sizes elute at different times. The eluted complexes are characterized in terms of composition and molar mass by means of MALS. Instrumentation for size exclusion chromatography is well known, and is available, for example, from Agilent, Inc. of Palo Alto, Calif. Instrumentation for MALS measurements is available from Wyatt Technology Corporation of Santa Barbara, Calif.

SEC-MALS measurements can take a relatively long time to complete. For example, some measurements may take at least 30 minutes. Moreover, complications to the measurements and/or analysis may be introduced due to interactions between the molecules of interest, or the solvents, and the column beads. Additionally, in the course of passing through the column, the initial composition may change as the sample separates and dilutes. Moreover, although SEC-MALS can provide an absolute measure of molar mass and can readily resolve unbound states from complexes in which the ratio of constituent molar masses is on the order of 5:1, the resolution of a SEC-MALS measurement is often insufficient to provide an accurate screen of binding between molecules having greater size disparities. For example, resolution of SEC-MALS systems may be insufficient to determine whether a 150 kDa antibody binds with a 10 kDa antigen.

Systems and methods disclosed herein can remedy or reduce one or more of the limitations of the assaying approaches discussed above. For example, various embodiments described hereafter employ static light scattering (e.g., multi-angle light scattering) and are suitable for high-throughput screening of macromolecular binding. Certain of such embodiments can exhibit advantages of label-free, in-solution analysis, including low probabilities of registering false positives or false negatives, and also can automate the analysis of multiple target compounds (e.g., for large target libraries), consume relatively small sample amounts, have sufficient sensitivity to detect binding (or binding inhibition) of molecular complements that have highly disparate weights, and/or perform measurements relatively quickly.

Certain embodiments may be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used.

Embodiments may include various steps, stages, or control events, which may be embodied in machine-executable instructions to be executed by a general-purpose or special-purpose computer (or other electronic device). Alternatively, the steps, stages, or control events may be performed by hardware components that include specific logic for performing the steps or by a combination of hardware, software, and/or firmware.

Embodiments may also be provided as a computer program product that includes a machine-readable medium having stored thereon instructions that may be used to program a computer (or other electronic device) to perform the processes described herein. The machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/computer-readable medium suitable for storing electronic instructions.

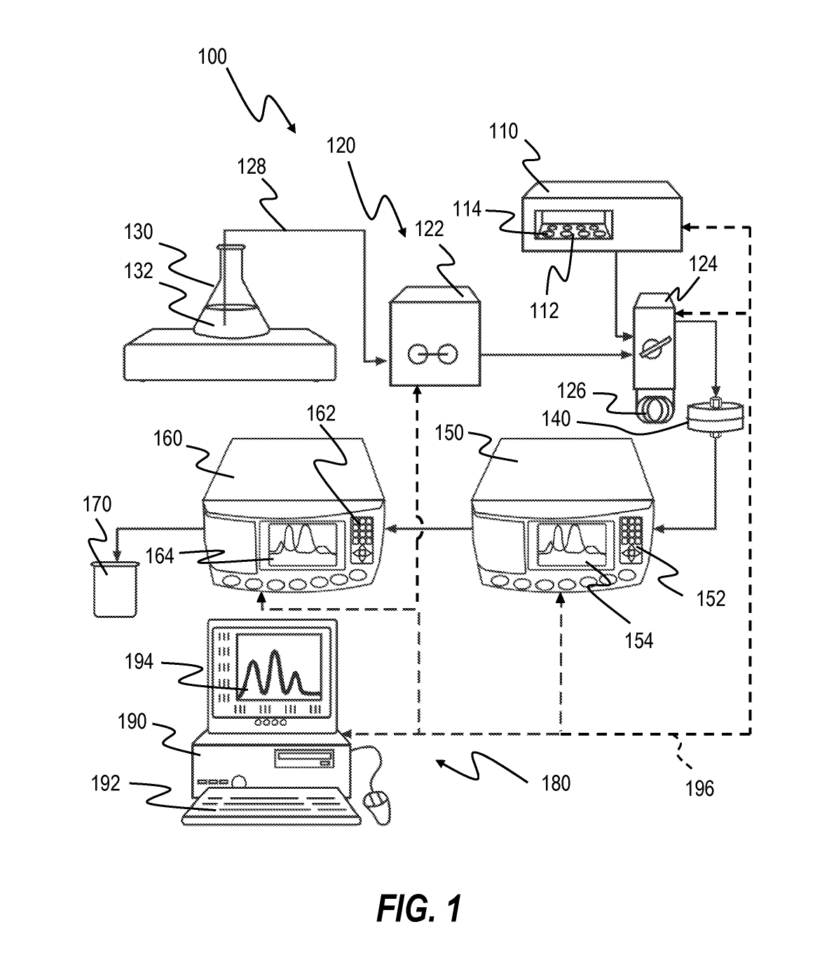

FIG. 1 illustrates an embodiment of a high-throughput screening (HTS) system 100 that is configured to rapidly and/or efficiently screen for binding between a target molecular species and a test molecular species. Test samples of the molecular species can be introduced into a solvent stream in an efficient and automated fashion, which can allow for relatively quick measurements. Detectors can be configured to take measurements of the solvent stream, which likewise can allow for relatively quick measurements. For example, in some implementations, the detectors can take measurements of the solvent stream as it flows in a substantially continuous manner. Algorithms for processing the measurements obtained via the detectors can be well-suited for determining whether binding between the target and test molecular species does or does not occur.

The terms “target” and “test” with respect to molecular species may be used interchangeably herein, as the term “target” does not necessarily imply that properties of a target molecular species are known, nor does the term “test” necessarily imply that properties of a test molecular species are unknown. Rather, the terms “test” and “target” are used more generally to denote an anticipated or potential pairing. For example, in some instances, a target molecular species may have known properties and a test molecular species having unknown properties may be screened against the target molecular species, whereas in other instances, a target molecular species may have unknown properties and a test molecular species having known properties may be screened against the target molecular species. In various embodiments, the target and test molecular species may comprise a reversibly associating ligand/receptor pair, such as an enzyme/inhibitor pair, an antibody/antigen pair, or a molecular chaperone system. As discussed further below, in some embodiments, the HTS system 100 is configured to screen for binding between a target molecular species and a library of different test molecular species.

The illustrated HTS system 100 includes an autosampler 110, which can be configured to automatically sample a plurality of solutions. Any suitable autosampler arrangement known in the art or yet to be devised may be used for the autosampler 110. In the illustrated HTS system 100, the autosampler 110 includes a microwell plate 112 that comprises a series of reservoirs or microwells 114. In other implementations, the autosampler may include a series of vials (not shown) in addition to or instead of the microwells 114. In some instances, each microwell 114 or vial can include a different solution. For example, one microwell 114 can include a quantity of a target molecular species in solution, another microwell 114 can include a quantity of a test molecular species in solution, and another microwell 114 can include a mixture of the target and the test molecular species (and, potentially, complexes thereof) in solution. In further implementations, the microwell plate 112 can include a library of test solutions. For example, the microwell plate 112 can include a first group of microwells 114 and a second group of microwells 114; each microwell 114 in the first group can include a solution having a different test molecular species, and each microwell 114 in the second group can include a solution having a mixture of one of the different test molecular species and the target molecular species. Preparation of the mixed samples may be manual, automated by via the autosampler, or automated by any other suitable fluid handling method or system.

The autosampler 110 can be configured to selectively, separately, and/or sequentially draw solutions from the microwells 114 and introduce them into a fluid delivery system 120. In the illustrated embodiment, the fluid delivery system 120 includes a pump 122, an injector valve 124 that includes a sample loop 126, and a series of fluid lines 128. One of the fluid lines 128 can be in fluid communication with a solvent reservoir 130 from which a solvent 132 can be drawn. As discussed further below, in some embodiments, the solvent 132 within the solvent reservoir 130 can be of the same variety as that contained in the solutions within the microwells 114.

The pump 122 can be of any suitable variety (e.g., standard chromatography pump), and can be configured to urge a stream of the solvent 132 through the fluid lines 128. The injector valve 124 can be of any suitable variety, and can be configured to transition between a “load” orientation and an “inject” orientation. When the injector valve 124 is in the “load” orientation, the stream of solvent 132 bypasses the sample loop 126, and when the injector valve 124 is in the “inject” orientation, the stream of solvent 132 passes through the sample loop 126 and mixes with the contents thereof. In some instances, fluid flow through the injector valve 124 can be substantially continuous or uninterrupted, even when the injector valve 124 transitions between the “load” and “inject” orientations.

In the illustrated HTS system 100 system 100, the autosampler 110 is configured to deliver aliquots of solution from the microwells 114 to the sample loop 126 when the injector valve 124 is in the “load” orientation. Each aliquot is then introduced into the solvent stream when the valve 124 transitions to the “inject” orientation. In some instances, the aliquots that are introduced into the solvent stream are relatively small. For example, the aliquots can be sized within a range of from about 1 microliter to about 100 microliters or from about 50 microliters to about 100 microliters, or are no greater than about 100 microliters, no greater than about 50 microliters, or no greater than about 1 microliter.

The illustrated HTS system 100 includes a filter 140 within a fluid line 128. The filter 140 can remove dust or other foreign particles that could degrade or otherwise interfere with light scattering measurements of the solvent stream.

The HTS system 100 can include a light scattering detector 150 that is configured to measure light scattering properties of fluids delivered thereto via a fluid line 128. The light scattering detector 150 can be configured to measure the intensity of scattered light via any suitable technique. For example, a high-intensity monochromatic light source can impinge on a stream of solvent that passes through the light scattering detector 150, and one or more detector devices can be used to measure the intensity (e.g., the time-averaged intensity) of scattered light at one or more angles relative to the line of prorogation of the incident light, which is commonly referred to as static light scattering detection. The light scattering detector 150 can comprise any suitable static light scattering detection device or system that is known in the art or that is yet to be devised. For example, in various implementations, the light scattering detector 150 can comprise a multi-angle static light scattering detector. For example, some systems can include a DAWN® HELEOS® II 18-angle static light scattering detector, which is available from Wyatt Technology Corporation of Santa Barbara, Calif. In other systems, the light scattering detector 150 can include more or fewer detector elements than are used in a DAWN® HELEOS® II detector and/or can include more or fewer detector elements that are situated over a relatively larger or smaller range of angles, respectively, than those in a DAWN® HELEOS® II detector. For example, in some systems, the light scattering detector 150 detects static light scattering at a single angle.

In the illustrated HTS system 100, the light scattering detector 150 includes a keypad 152 and a display 154. The keypad 152, or any other suitable data entry interface, can be used to provide instructions to the light scattering detector 150, such as to select desired settings. The display 154 may be used to visually monitor measurements made by the light scattering detector 150, if desired. As discussed further below, in other systems, the display 154 and/or the keypad 152 may be omitted.

The illustrated HTS system 100 further includes a concentration detector 160. The concentration detector 160 can comprise any suitable concentration detector that is known in the art or that is yet to be devised, such as an online refractive index detector or UV absorption detector. For example, in some embodiments, the concentration detector 160 can comprise an Optilab® rEX, which is available from Wyatt Technology Corporation of Santa Barbara, Calif. In some systems, the concentration detector 160 can include a keypad 162 or other suitable data entry interface and/or a display 164.

The concentration detector 160 is in series with the light scattering detector 150 such that fluid is delivered to the concentration detector 160 from the light scattering detector 150 via a fluid line 128. Fluid that exits the concentration detector 160 can be delivered to a waste reservoir 170. Other arrangements of the concentration detector 160 are also possible. For example, the fluidics can be arranged such that the concentration detector 160 is in parallel with the light scattering detector 150, or the concentration detector 160 can be omitted.

The fluid delivery system 120 can be configured for use with small aliquots provided via the autosampler 110. For example, in some arrangements, the fluid lines 128 include tubing having a relatively small inner diameter. Similarly, flow cells (not shown) within the light scattering detector 150 and the concentration detector 160 can be relatively small.

The HTS system 100 can include a control system 180, which may also be referred to herein as an analysis system or as a control and analysis system. The control system 180 can include a computer 190 that has been specially configured to operate in the manners described herein. In some systems, the configuration or operation instructions may be stored on a separate machine-readable medium that is provided to a general purpose computer 190. In other systems, the configuration or operation instructions may be hardwired into the computer 190. The computer 190 may include any suitable storage or memory devices (not shown). In the illustrated HTS system 100 the computer 190 includes peripheral data entry devices 192, such as a keyboard and a mouse, via which instructions can be provided to the computer 190. The computer 190 further includes a display 194.

The control system 180, in some arrangements, can further include dedicated control hardware within each of the concentration detector 160, the light scattering detector 150, the autosampler 110, the injector valve 124, and/or the pump 122. For example, the light scattering detector 150 can comprise dedicated hardware that is configured to control operation of the light scattering detector 150 based on instructions provided thereto via the keypad 152, which can be considered as part of the control system 180 of the HTS system 100.

The computer 190 can communicate with the concentration detector 160, the light scattering detector 150, the autosampler 110, the injector valve 124, and/or the pump 122 via any suitable interface, whether wired or wireless. In the illustrated system, electrical interfaces are depicted via broken lines 196. The computer 190 is depicted as a unit that is separate from other components of the HTS system 100. In other systems, any suitable combination of the various components can be combined in a single unit. For example, in some systems, the computer 190, the concentration detector 160, the light scattering detector 150, and/or the autosampler 110 can be comprised in a single unit, which may have a single screen 194 and a single set of data entry devices 192. Further, the computer 190, the concentration detector 160, the light scattering detector 150, and/or the autosampler 110, either combined or separately, can include a special purpose processor configured to perform the processes described herein. In some systems, the computer 190, the concentration detector 160, the light scattering detector 150, and/or the autosampler 110, either combined or separately, may include a general purpose processor configured to execute computer executable instructions (e.g., stored in a computer-readable medium) to perform the processes described herein.

In an initial operation stage, the computer 190 can cause the injector valve 124 to transition to the “load” orientation (unless it is already in this orientation). The computer 190 can cause the pump 122 to draw solvent 132 from the reservoir 130 and into the fluid line 128, through the injector valve 124 and the filter 140, and into the light scattering detector 150. The light scattering detector 150 can take measurements of light scattering signals from the pure solvent stream as it flows therethrough. These measurements may be delivered to the computer 190 and/or stored. For example, the measurements may be stored locally in the light scattering detector 150 and/or within the computer 190, and the measurements may be delivered to the computer 190 in analog or digital format. The measurements of the light scattering properties of the pure solvent 132 represent a “baseline” from which further measurements will deviate when solutions are within the solvent stream.

The pure solvent stream can continue through the concentration detector 160, which can take measurements of concentration signals as the stream flows therethrough. These measurements may be delivered to the computer 190, and likewise may be stored. The measurements of the concentration properties of the pure solvent 132 represent a “baseline” from which further measurements will deviate when solutions are in the solvent stream.

To obtain measurements of a sample, the computer 190 instructs the autosampler 110 to deliver an aliquot of a test solution from a microwell 114 into the sample loop 126. Once the aliquot is within the sample loop 126, the computer 190 instructs the injector valve 124 to transition from the “load” orientation to the “inject” orientation. When this occurs, the solvent stream passes through the sample loop 126 and mixes with the test solution aliquot. The test solution then is carried in the solvent stream through the filter 140 and into the light scattering detector 150. The light scattering detector 150 can take measurements of the light scattering properties of the solvent stream as it flows therethrough. The measurements will deviate from the baseline due to the molecular species that is within the test solution. These measurements may be delivered to the computer 190 and/or stored.

Similarly, the test solution can be carried in the solvent stream through the concentration detector 160, which can take measurements of the concentration properties of the solvent stream as it flows therethrough. The measurements will deviate from the baseline due to the molecular species that is within the test solution. These measurements may be delivered to the computer 190 and/or stored.

The injector valve 124 can be maintained in the “inject” orientation until the test sample has been fully flushed from the sample loop 126. For example, the computer 190 may read or monitor the signals detected by the light scattering detector 150 and/or the concentration detector 160 to determine when the signals have returned to one or more of the respective light scattering and concentration baseline values. The time associated with the execution of a complete measurement event (e.g., loading, measuring, and clearing of a test solution) can depend on a variety of factors, which may be altered or optimized as needed or desired. For example, the time may be affected by flow rate of the solvent stream, the volume of the tubing used for the fluid lines 128, etc. In various embodiments, execution of a complete measurement event may take from about 30 to about 60 seconds, or it may take no more than about 30, 45, or 60 seconds.

Upon determining that the sample loop 126 has been cleared of the test solution, the computer 190 may instruct the injector valve 124 to return to the “load” orientation, and may instruct the autosampler 110 to deliver a different test solution into the sample loop 126. The foregoing processes may be repeated for each test solution contained in the microwell plate 112. The automated, sequential measurement events may proceed relatively quickly.

As previously mentioned, the flow of solvent 132 through the light scattering detector 150 and the concentration detector 160 can be substantially continuous, in some arrangements. Stated otherwise, the detectors 150, 160 may operate in a “continuous flow” mode, rather than in a “stop-flow” or “batch” mode. Such stop-flow modes or batch modes are commonly known, and can be used to halt fluid flow within the flow tubes of detectors so as to maintain a test sample of a known composition (e.g., concentration of test and target species) within a constrained volume to allow for time-dependent measurements of the sample. As further discussed below, in some implementations, measurements obtained via the detectors 150, 160 can be integrated over relevant time intervals, which can avoid the time-consuming steps of stopping fluid flow and obtaining time-dependent measurements of a constrained volume of fluid. Operation in a continuous-flow mode can increase the screening speed of the HTS system 100 and/or can reduce the sample volumes used.

After measurements of a particular set of samples have been obtained via the light scattering detector 150, and after further measurements optionally have been obtained via the concentration detector 160, the computer 190 can analyze the measurements to determine whether a particular test molecular species binds with a target species. In some cases, three separate solutions may be used to determine whether, or how well, a particular test molecular species binds with the target molecular species.

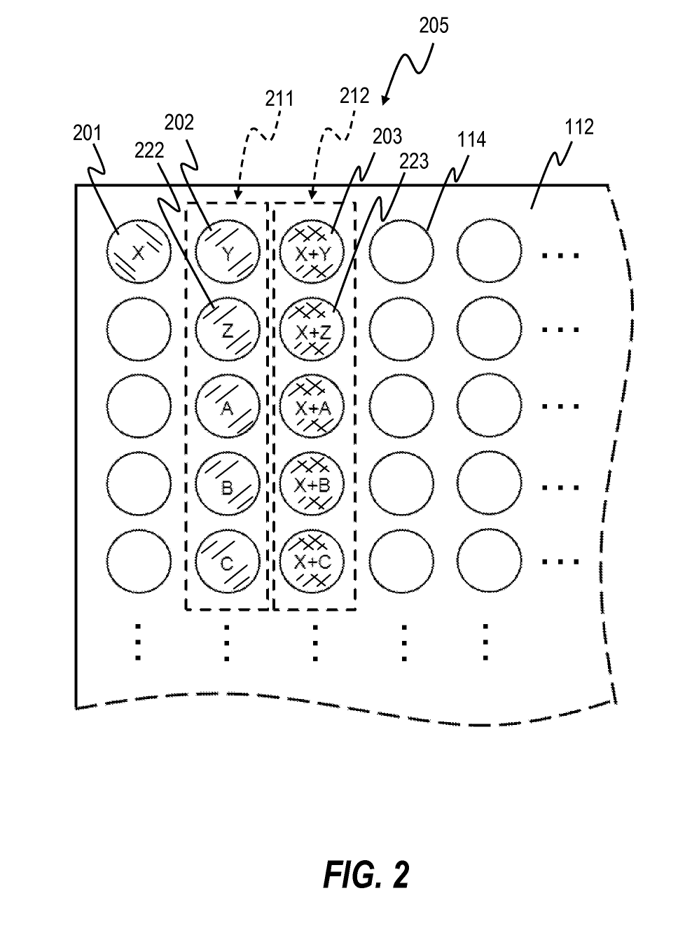

FIG. 2 schematically illustrates a portion of a microwell plate 112 in which some of the microwells 114 include solutions therein. A first solution 201 can include a target molecular species X, a second solution 202 can include a test molecular species Y, and a third solution 203 can include a combination of the target molecular species X and the test molecular species Y. In some instances, it may be desirable to allow the third solution 203 to achieve an association/dissociation equilibrium between the target and test species X, Y prior to introduction of the solution into the sample loop 126.

The test solutions 201, 202, 203 can be separately introduced into the fluid delivery system 120, and physical properties thereof can be measured via the light scattering detector 150 and/or the concentration detector 160 in manners such as described above. As further discussed below, the computer 190 can be configured to compare the measured light scattering properties of the third solution 203 with a combination of the measured light scattering properties of the first and second solutions 201, 202 to determine whether the test molecular species Y binds with the target molecular species X. Other analyses also can be performed, as further discussed below.

Additional test molecular species may be screened to determine whether, or how well, they bind with the target molecular species. For example, the microwell plate 112 may contain a library 205 of test solutions. The library 205 can include a first group 211 of solutions and a second group 212 of solutions that may be sampled and evaluated in conjunction with the target solution 201. Each solution in the first group 211 can include a different test molecular species Y, Z, A, B, C. The second group of 212 can correspond to the first group 211, in that each of the different test molecular species Y, Z, A, B, C can be included, respectively, in one of the solutions of the second group 212. Further, each solution of the second group 212 can also include a quantity of the target molecular species X. Properties of each solution of the first and second groups 211, 212 can be measured via the detectors 150, 160, and the resultant measurements can be compared or otherwise analyzed in manners such as described above. The properties of the target solution 201 may be measured only once in conjunction with the multiple sets of solutions in the first and second groups 211, 212, which can result in quicker screening times. In some systems, light scattering and/or concentration properties of the target solution 201 can be repeated after every approximately 50, 60, 70, 80, 90, or 100 injections.

Following are illustrative examples of methods that may be employed via the HTS system 100. By way of illustration, certain methods discussed hereafter can be employed with embodiments depicted in and described with respect to FIGS. 1 and 2. Reference is made throughout to illustrative monomers X and Y, which can correspond to the illustrative target molecular species X and test molecular species Y identified in FIG. 2. Additionally, calculations and other operations may be performed by any suitable portion of the control and analysis system 180, such as via the computer 190.

In the limit of very dilute solutions, light scattering from a solution of molecules under observation by the light scattering detector 150 can be described by the following equation:

$$\frac{R ( \overline{μ} , θ )}{K} = {\sum }_{i} {M}_{i}^{2} {{μ}_{i} ( \frac{d n}{d {c}_{i}} )}^{2} {P}_{i} ( θ ) . \qquad ( 1 )$$

Here, R( μ̅,θ) represents the excess Rayleigh ratio detected at any scattering angle θ from a solution of macromolecules that has a composition μ̅=[μ₁, μ₂, μ₃, . . ], where μ₁, μ₂, μ₃, etc. represent the molar concentrations of each species present in the solution. The species can include both the free monomers within the solution, as well as the complexes that form from the monomers. The excess Rayleigh ratio is the difference between the Rayleigh ratio of the solution and that of a pure solvent (e.g., the solvent 132). The Rayleigh ratio of a solution is Iₛrₛ²/Iv, where Iₛ represents the intensity of scattered light per unit solid angle observed at a distance rₛ from the point of scattering due to an incident intensity I, and v is the scattering volume.

In Equation 1, the constant K is defined as follows:

$$K = \frac{{( 2 π {n}_{0} )}^{2}}{{N}_{A} {λ}_{0}^{4}} ,$$

where n₀ is the refractive index of the solution, N_{A} is Avogadro's number, and λ₀ is the wavelength of the incident light in vacuum. The term i represents a counting number (i.e., 1, 2, . . . n) for each different species that is present, including free monomers and complexes. Accordingly, μᵢ represents the molar concentration of the i^{th} species, and dn/dcᵢ represents the differential refractive index of the i^{th} species. If the i^{th} species is a heterocomplex consisting of i_{X} monomers of type X, i_{Y} monomers of type Y, etc., then dn/dcᵢ is the weight average of the contributing refractive index increments of the constituent molecules. The weight average of the refractive increments is

$$\frac{{\sum }_{q} {i}_{q} {M}_{q} \frac{d n}{d {c}_{q}}}{{\sum }_{q} {i}_{q} {M}_{q}} ,$$

where the subscript q refers to the different constituent monomers.

In Equation 1, the term Pᵢ(θ) is defined as follows:

$${P}_{i} ( θ ) = 1 - \frac{16 {π}^{2} {n}_{0}^{2}}{3 {λ}_{0}^{2}} 〈 {( {r}_{g , i} )}^{2} 〉 {sin}^{2} ( θ / 2 ) + … ,$$

which represents the angular dependence of the scattered light, within a plane that is perpendicular to the vertically polarized incident light, for the i^{th} species. The angle θ is measured relative to the direction of propagation of the beam, and [symbol] (r_{g,i})² [symbol] , which is defined as [symbol] (r_{g,i})² [symbol] =∫r²dmᵢ/∫dmᵢ, is the mean square radius of the i^{th} species. In this expression, r is the distance from the center of mass of the molecule to a molecular mass element mᵢ, integrated over all mass elements of the molecule.

The angular measurements of R( μ̅,θ) can be extrapolated to zero angle, thereby reducing Equation 1 to the following:

$$\frac{R ( \overline{μ} , 0 )}{K} = {\sum }_{i} {M}_{i}^{2} {{μ}_{i} ( \frac{d n}{d {c}_{i}} )}^{2} \qquad ( 2 )$$

It can readily be shown that the excess Rayleigh ratio corresponding to an equimolar solution of X and Y monomers in which all of the monomers have associated to form complexes having a stoichiometry of [i_{X},i_{Y}] is larger than that corresponding to an equimolar solution of the X and Y monomers at the same overall concentrations in which the monomers are free and unassociated. As an example, if a complex is formed of two proteins with the same refractive increment, then the relative difference, Δ, of the two Rayleigh ratios for equimolar solutions can be expressed as:

$$\begin{matrix}Δ = \frac{{R ( \overline{μ} , 0 )}_{associated} - {R ( \overline{μ} , 0 )}_{unassociated}}{{R ( \overline{μ} , 0 )}_{unassociated}} \\ = \frac{2 {i}_{X} {i}_{Y} {M}_{X} {M}_{Y} ( \frac{d n}{d {c}_{X}} ) ( \frac{d n}{d {c}_{Y}} )}{{[ {i}_{X} {M}_{X} ( \frac{d n}{d {c}_{X}} ) ]}^{2} + {[ {i}_{Y} {M}_{Y} ( \frac{d n}{d {c}_{Y}} ) ]}^{2}}\end{matrix} \qquad ( 3 )$$

An illustrative complex may consist of a 1:1 stoichiometry (i.e., i_{X}=i_{Y}=1), where both molecules have the same value of dn/dc. If the molar masses of the two monomers are equal, then Δ is equal to 1, or stated otherwise, the MALS signal of the associated solution is 100% higher than that of the unassociated solution.

Often, the molar mass of one monomer will be much larger than the other. For example, the molar mass M_{X} of a target molecular species may be 150 kDa, whereas the molar mass M_{Y} of a test molecular species may be only 5 kDa (i.e., 30 times smaller). Even in this example, the value of Δ will be appreciable (i.e., 6.7%). Certain MALS detectors can readily distinguish between signals that differ by only about 2% to 3%. Accordingly, such detectors would be capable of discriminating between associated and unassociated solutions, even when the molar masses vary by a factor of 30. In some arrangements, the HTS system 100 can be configured to discriminate between associated and unassociated solutions where the molar mass of one of a test and a target molecular species is greater than the molar mass of the other of the test and the target molecular species by a factor of no less than about: 15, 20, 25, 30, 35, 40, 45, or 50. Other arrangements of the HTS system 100 may be capable of discriminating between associated and unassociated solutions where larger or smaller disparities between the masses of the test and target molecular species are present.

Providing both associated and unassociated solutions for comparison may be difficult in some instances. However, the signal for an unassociated solution may be calculated directly from the light scattering signals of solutions of the pure monomers. Accordingly, it is possible to compare the properties of a pure solution of the monomer X and a pure solution of the monomer Y with the properties of a solution that contains a mixture of the monomers X and Y (and, potentially, complexes thereof). In some cases, it can be desirable for the mixture of the monomers X and Y to be equimolar, or substantially equimolar. Stated otherwise, the solution may desirably contain the same or substantially the same molar amounts of the X and Y monomers. Additionally, the comparison may be facilitated where all three solutions are formulated in solvents having equal refractive indices.

However, in other implementations, a mixture of the monomers X and Y may not be equimolar. In such instances, the light scattering signal from the associated solution can still be larger than for the unassociated solution, but by a smaller relative difference than for an equimolar associated solution. Accordingly, the range of measurement for general, non-equimolar solutions may not be as large as for equimolar solutions.

The degree of association of certain 1:1 reversibly associating complexes can be determined by the concentrations of the species in solution and their binding affinity K_{d}, as per the following equation:

$${K}_{d} = \frac{{μ}_{X} {μ}_{Y}}{{μ}_{XY}} \qquad ( 4 )$$

Here, μ_{X}, μ_{Y}, and μ_{XY} represent the molarities of the free X and Y monomers, and complexes [X,Y] thereof, in equilibrium. Nearly all of the available monomers may be associated where at least one of μ_{X} and μ_{Y} is large as compared with K_{d}. Where a solution contains insufficient concentrations of the X and Y monomers for nearly complete association, the value of the relative difference Δ may be reduced relative to the value expected for complete association. Hence, the discrimination between association and non-association can be limited by the concentrations of the individual species within a mixture relative to the binding affinity K_{d}. Accordingly, a given set of concentrations of the X and Y monomers may set an upper limit on the value of K_{d}. This can affect, for example, the size disparities of the X and Y monomers for which successful screening for binding may be achieved.

With reference again to FIG. 2, in certain embodiments, the first solution 201 and the second solution 202 contain pure solutions of the monomers X and Y, respectively, and the third solution 203 contains a mixture of the monomers X and Y. In view of the foregoing discussion, in some cases, it can be desirable for the molar concentrations of the mixed solution 203 to be several times higher (e.g., no less than about: 2, 3, 4, 5, or 6 times higher) than the desired maximum value of the binding affinity K_{d} that is considered useful for screening. This can achieve a significant fraction of bound complexes at the weakest desirable binding affinity. In certain arrangements, the molar concentration of the pure solutions 201, 202 are approximately twice that of the individual monomers in the mixed solution 203.

In some embodiments, the monomers X and Y in the first and second solutions 201, 202, respectively, are substantially equimolar relative to each other, and further, the concentrations of the monomers X and Y are substantially equimolar within the third solution 203. In other embodiments, the monomers X and Y are non-equimolar, as compared between the solutions 201, 202, and further, are non-equimolar within the third solution 203. In further embodiments of either of the foregoing arrangements, it can be desirable for the third solution 203 to contain substantially equal parts of the pure solutions 201, 202 such that the molar concentration of each constituent molecule X, Y within the mixed solution 203 will be substantially one half that of the pure solution 201, 202, respectively. Stated otherwise, the value of μ_{X} for the pure solution 201 can be approximately double the value of μ_{X} for the mixed solution 203, and the value of μ_{Y} for the pure solution 202 can be approximately double the value of μ_{Y} for the mixed solution 203. Such concentration conditions in the mixed solution can readily be obtained by accurately mixing substantially equal parts of the two pure solutions 201, 202. Under such conditions, the excess Rayleigh ratio of a theoretical mixture of the pure solutions 201, 202 in which the monomers X and Y remain unassociated can be readily calculated as the average of the excess Rayleigh ratios of the two pure solutions 201, 202. Hence, under these concentration conditions, the light scattering signals of the actual mixed solution 203 may be directly compared to the average light scattering signal of the two pure solutions 201, 202 in order to determine whether association occurs. Other combinations of molar concentrations and methods for analyzing the light scattering signals obtained therefrom are also possible, as will be understood from at least the foregoing discussion.

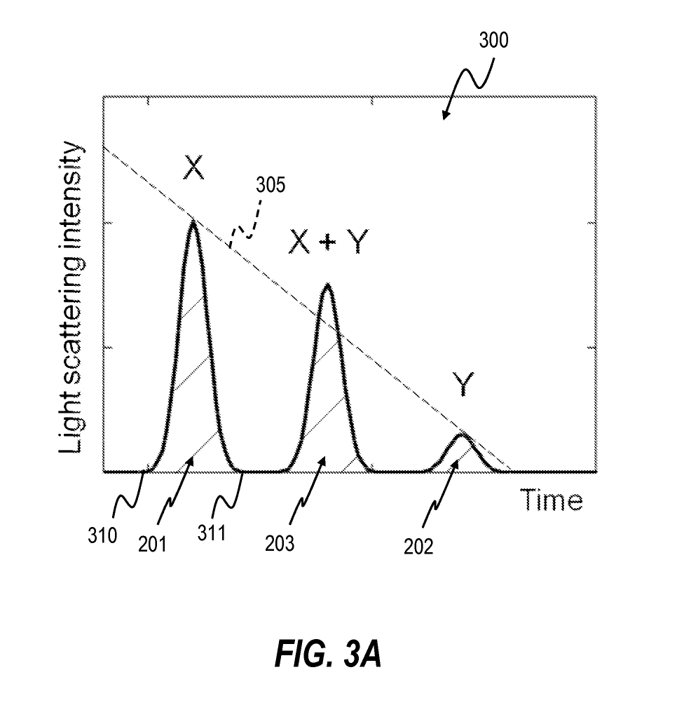

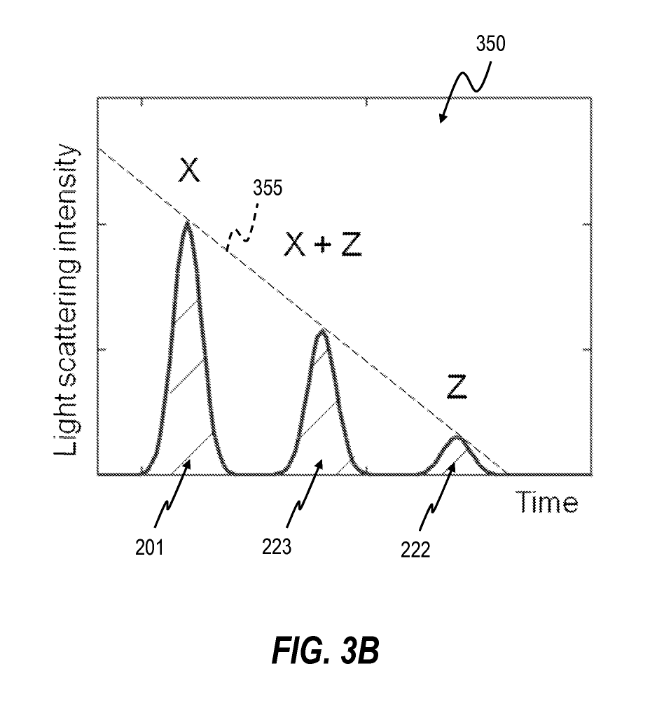

FIG. 3A depicts an illustrative graph 300 of light scattering signals that may be detected when aliquots of the solutions 201, 203, 202 (see FIG. 2) are passed sequentially through the light scattering detector 150. The solution 201 includes solely X monomers, the solution 203 includes a mixture of X and Y monomers, and the solution 202 includes solely Y monomers. The fixed total molar concentration of each of the solutions 201, 202, 203 are substantially identical. Moreover, the solution 203 includes equimolar concentrations of the X and Y monomers.

The vertical axis of the graph 300 represents light scattering intensity and the horizontal axis represents time. In the illustrated scenario, the solutions 201, 203, 202 are introduced into the fluid delivery system 120 at regular intervals. Additionally, the flow rate of the solvent stream is maintained at a substantially constant value.

The shape of each signal substantially defines a peak, rather than a “top hat” or “plateau,” due to dilution and mixing of each sample 201, 202, 203 with the solvent 132 as the solvent stream passes through the sample loop 126, as well as through the fluid lines 128 and the light scattering detector 150 (see FIG. 1). The horizontal axis corresponds with the “baseline” light scattering intensity value obtained from the pure solvent. Stated otherwise, the graph 300 shows that the signal from the pure solvent has been subtracted from the overall signal such that only the excess Rayleigh ratio is shown.

A view line 305 is included on the graph 300 to illustrate the peak value of the light scattering intensity of the mixed solution 203 relative to the average value of the pure solutions 201, 202. The fact that the peak value exceeds the average value can roughly indicate that the X and Y monomers bind with each other to form [X,Y] complexes.

However, since each sample may undergo different degrees of dilution and mixing, the signal from each solution can be integrated over a period of time to provide for a more accurate determination of whether binding takes place. Stated otherwise, whether or not a peak value of the signal obtained from the solution 203 exceeds the view line 305 would not necessarily always provide an accurate indicator as to whether or not the molecular species under consideration bind with each other. In some instances, for example, the area under the “X+Y” portion of the curve could be more spread out over time such that curve is situated entirely beneath the view line 305, even though the total light scattering of the solution 203 may in fact be greater than the combined total light scattering of the solutions 201 and 202.

The integrated areas under the three curves are depicted with cross-hatching. In the illustrated scenario, the beginning point of the integration period for the measurements obtained relative to the solution 201 is shown at reference numeral 310, and the ending point of the integration period is shown at reference numeral 311. As can be seen, the integration period begins at the time at which the light scattering intensity exceeds the baseline value and ends at the time at which the light scattering intensity returns to the baseline value (bearing in mind that a reading of “0” along the vertical axis of the graph 300 corresponds to the baseline value, as described above). This is true for each of the solutions 201, 202, 203. In other instances, it is possible to begin the integration for a given solution at a point subsequent to the departure of the light scattering intensity from the baseline value and/or is possible to end the integration at a point prior to the return of the light scattering intensity to the baseline value.

In certain embodiments, the angular light scattering signals can be extrapolated to zero angle to obtain R( μ̅,θ). Integration may then be performed on the extrapolated measurements to obtain R′_{X}, R′_{Y}, and R′_{X+Y} for the solutions 201, 202, and 203, respectively. It is also noted that in some embodiments, the flow rate of the solvent stream through the light scattering detector 150 can be maintained at a substantially constant rate, which can facilitate the integration. However, in other embodiments, the flow rate may be altered and integrated values can be adjusted accordingly.

Concentration signals from the solutions 201, 202, 203 may be similar to the light scattering signals shown in FIG. 3A. These signals likewise may be integrated in a similar manner. The integrated signals may be referenced to the sample response (e.g., the extinction coefficient for absorption measurements or dn/dc for differential refractometry measurements) and the flow rate of the solvent stream so as to obtain the total mass of each pure sample m_{X}, m_{Y} and m_{X+Y}. Calculation of m_{X+Y} from the measurements of a single concentration detector can be reliable where both X and Y have the same sample response; commonly, proteins have the same dn/dc value but different extinction coefficients. In some instances, however, more accurate measures of the total mass of each sample in the mixed aliquot can be determined using two concentration detectors using any suitable technique, as is known in the art.

A relative difference Δ can be determined to compare the detected properties of the combined solution 203 to those of the pure solutions 201, 202, where the molar concentration of the combined solution 203 is one half (or approximately one half) the molar concentration of each of the pure solutions 201, 202. The relative difference Δ can be calculated as follows:

$${Δ}^{′} = \frac{{R}_{X + Y}^{′} - {R}_{X}^{′} - {R}_{Y}^{′}}{{R}_{X}^{′} + {R}_{Y}^{′}} . \qquad ( 5 )$$

The relative difference Δ is generally a positive number, and is generally smaller than 100% for 1:1 associations. The relative difference Δ may be greater than 100% for higher stoichiometries (e.g., 2:1, 3:1, etc.).

For screening purposes, a threshold value T may be assigned. The calculated relative difference Δ for a group of solutions may be compared against the threshold value T to determine whether or not binding between a test molecular species and a target molecular species takes place. When the calculated relative difference Δ meets and/or exceeds the threshold value T, the test sample may be considered associating, and when the calculated relative difference Δ is below the threshold value T, the test sample may be considered non-associating. In various embodiments, the threshold value T may be set at a level that is approximately the same as, is slightly larger than, or significantly exceeds the percentage difference between signals that a particular light scattering detector 150 can distinguish. For example, certain embodiments of the light scattering detector 150 may only be able to distinguish between signals that differ from each other by only about 2% to 3%. In various embodiments, the threshold value T may be set at value that is at, or is no less than, about: 2%, 3%, 4%, 5%, 6%, or 7%. The size of the threshold value T may also be selected according to how strong of an association is desired or how desirable it may be to avoid false positives.

The optional concentration data obtained from the concentration detector 160 can provide additional information regarding the associating systems. For example, the concentration data may be used in conjunction with the light scattering data to determine the total injected molar quantities μ′_{X} and μ′_{Y} of the source monomers in the pure solutions as follows:

$${μ}_{X}^{′} = \frac{{m}_{X}^{2}}{{{R}_{X}^{′} ( d n / d {c}_{X} )}^{2}} , \\ {μ}_{Y}^{′} = \frac{{m}_{Y}^{2}}{{{R}_{Y}^{′} ( d n / d {c}_{Y} )}^{2}} .$$

Using this information, it can be possible to calculate a best-case theoretical value of the relative difference Δ, which is denoted herein as Δ′_{best}, where certain conditions are met. For example, if the pure solutions 201, 202 were mixed in equal parts in order to form the mixed solution 203, and assuming a complete association of a 1:1 complex under non-equimolar conditions, then the best-case theoretical value Δ′_{best} can be calculated as follows:

$${Δ}_{best}^{′} = \frac{2 {M}_{X} {M}_{Y} {μ}_{min}^{′} ( \frac{d n}{d {c}_{X}} ) ( \frac{d n}{d {c}_{Y}} )}{{M}_{min}^{2} {{μ}_{min}^{′} ( \frac{d n}{d {c}_{min}} )}^{2} + {M}_{max}^{2} {{μ}_{max}^{′} ( \frac{d n}{d {c}_{max}} )}^{2}} . \qquad ( 6 )$$

Here, μ′ₘᵢₙ refers to the smaller of μ′_{X} and μ′_{Y}, and μ′ₘₐₓ refers to the larger, while Mₘᵢₙ and Mₘₐₓ refer to the molar masses, and dn/dcₘᵢₙ and dn/dcₘₐₓ refer to the refractive increments, of those species corresponding to μ′ₘᵢₙ and μ′ₘₐₓ, respectively. As previously indicated, any of the foregoing computations and analysis of the measurements obtained via one or more of the light scattering detector 150 and the concentration detector 160 can be performed by the computer 190 and/or any other suitable component of the control and analysis system 180.

As previously discussed, the HTS system 100 can be configured for rapid screening of multiple different test molecular species against a target molecular species. With reference again to FIG. 2, and with reference to FIG. 3B, another stage in a screening of the library 205 is depicted. In particular, FIG. 3B depicts an illustrative graph 350 (similar to the graph 300) of light scattering signals that may be detected when aliquots of the solutions 201, 223, 222 are passed sequentially through the light scattering detector 150. As previously indicated, the solution 201 includes solely X monomers. The solution 223 includes a mixture of X and Z monomers (where Z is different from the illustrative monomer Y discussed above), and the solution 222 includes solely Z monomers. For the illustrative graph 350, the fixed total molar concentration of each of the solutions 201, 222, 223 are substantially identical. Moreover, the solution 223 includes equimolar concentrations of the X and Z monomers.

A view line 355 is included on the graph 350 to illustrate the peak value of the light scattering intensity of the mixed solution 223 relative to the average value of the pure solutions 201, 222. The fact that the peak value is approximately equal to the average value (i.e., touches the view line) can roughly indicate that the X and Z monomers do not bind with each other, or stated otherwise, do not form [X,Z] complexes. However, as previously discussed, since each sample may undergo different degrees of dilution and mixing, the signal from each solution may be integrated over a period of time to provide for a more accurate determination of whether binding may in fact take place.

The relative difference Δ can be calculated for the solutions 201, 222, 223 in the manner discussed above and may be compared against a preset threshold T. Also, where concentration measurements are taken with respect to the solutions 201, 222, 223, they may resemble the graph 350.

Although the target solution 201 was measured once again in creating the graph 350, it is noted that, as previously discussed, it is possible to forgo additional measurements of the target solution 201 as a time- and material-saving measure. For example, the initial measurements regarding the target solution 201, which were made with respect to the graph 300, may be stored in memory and accessed as needed or desired with respect to the measurements regarding any of the test solutions in the library 205. For example, in order to complete a screening of the library 205, it is possible to take measurements only with respect to the remaining solutions in each of the test groups 211, 212, and any further calculations, comparisons, or other operations can be performed using the stored information regarding the target solution 201.

In completing a full screen of the library 205, it can be possible to determine a level of confidence for each molecular species that is tested. In this manner, a ranking of the molecular species may be achieved. For example, the test molecular species may be ranked according to how well they bind with the target molecular species. One confidence level, or confidence value, may be calculated as follows:

$$η = \frac{{( {Δ}^{′} )}^{2}}{{Δ}_{best}^{′} \cdot T} ,$$

which represents a product of (1) the ratio of the calculated relative difference Δ to the best-case theoretical value Δ_{best} and (2) the ratio of the calculated relative difference Δ to the screening threshold T. The target molecules may be classified by the confidence level η, or similar figures of merit, in order to estimate the most likely or desirable candidate-target combinations.

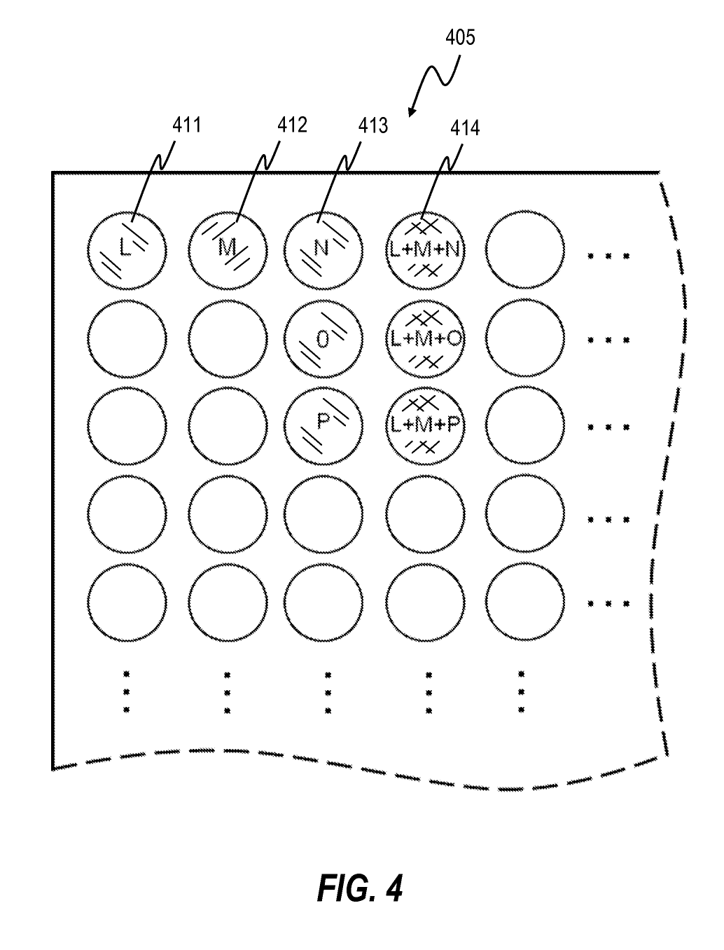

In some embodiments, the HTS system 100 can be used in manners similar to those described above to test whether a molecular species inhibits binding between other molecular species. For example, as shown in FIG. 4, a screening library 405 can include a first solution 411 that includes a first molecular species L and a second solution 412 that includes a second molecular species M. The first and second molecular species L, M may be known to bind with each other to form complexes [L,M]. The library 405 can further include a first group of test solutions that each includes a single test molecular species N, O, P, as well as a second group of test solutions that each includes a combination of the first and second molecular species L, M and a respective one of the test molecular species N, O, P.

Measurements and analysis of the contents of the library 405 can proceed in manners such as those described above with respect to the library 205. For example, the properties of the solutions 411, 412 may be measured only once, or relatively infrequently, during the screening of the full library 405 (similar to the target solution 201). Likewise, testing of the solutions in the third and fourth columns of the library 405 can proceed in a manner similar to the testing of the second and third columns of the library 205. In some embodiments, it can be desirable to permit the fourth column of solutions in the library 405 to incubate for a relatively long period prior to their introduction into the fluid delivery system 120. For example, it can be desirable to wait a sufficient time to allow equilibrium to be reached for these solutions.

A relative difference Δ of each set of solutions from the library 405 (e.g., the solutions 411, 412, 413, 414 can constitute one set) can be calculated in a manner similar to that described above. Similarly, a threshold value T can be set. In comparing the relative difference Δ to the threshold value T, positive results may be found where the relative difference Δ is below the threshold value T.

It is to be appreciated that other embodiments can vary from those depicted in the drawings and described herein. For example, in some embodiments, the autosampler 110 and/or the injector valve 124 may be replaced with other fluid handling apparatus. In other or further embodiments, the concentration detector 160 may be eliminated.

In view of the foregoing, it is also to be appreciated that methods of screening molecular species for binding, or for the inhibition of binding, can include a any suitable combination of the steps or stages described herein. For example, in various embodiments, methods can include any suitable combination of the following:
Providing at least one candidate molecule and a plurality of target compounds.
Providing apparatus including one or more of an autosampler, pump, solvent reservoir, waste reservoir, injector valve, sample loop, MALS detector, optional concentration detector, and other fluid handling or preparation components as may be desired, as well as a computer to control the autosampler and read and record the detector signals.
Providing samples in vials or microwell plates as may be appropriate to a particular autosampler, wherein the samples include pure solutions of the candidate molecule at a molar concentration several times higher than a desired screening value of the dissociation constant K_{d}; pure solutions of the target compounds at approximately the same molar concentration as the candidate; and mixtures consisting of equal parts of the pure candidate and target solutions.
Providing a solvent in the solvent reservoir; in certain embodiments, the same solvent as is used in preparing the sample solutions.
Pumping solvent through the detectors and measuring and recording the light scattering and concentration signals of the pure solvent.
Drawing aliquots of each solution in turn into the sample loop, injecting the aliquots into the fluid stream so that they pass through the detectors, and measuring and recording the light scattering and concentration signals due to the various samples.
Processing the light scattering and concentration signals, including subtracting the pure solvent signals and/or, for the light scattering data, extrapolating the angular dependence to zero angle to obtain R( μ̅,0).
Integrating the concentration signal and R( μ̅,0) for the aliquot containing the candidate molecular species (e.g., an “X”-type molecular species), for each aliquot containing a separate target substance (e.g., a “Y”-type molecular species), and for each “X+Y” mixed solution to obtain R′_{X}, R′_{Y}, R′_{X+Y}.
Setting a threshold value T, which can correspond to the smallest difference in light scattering signals that may reliably be detected. The value of T can depend on the desired degree of confidence and allowable fraction of false positives or false negatives, as can be determined from known statistical analysis techniques.
For each target compound, calculating the relative difference Δ and comparing the calculated relative difference Δ with the threshold T in order to determine whether or not the target compound and candidate compound bind. For binding assays, determining a positive result where the relative difference Δ′>T, and for inhibition assays, determining a positive result where the relative difference Δ′<T.
Estimating Δ′_{best}, η, and/or similar figures of merit derived from the light scattering and concentrations signals in order to further classify the target compounds according to the degree of confidence in the binding test.

It will be understood by those having skill in the art that changes may be made to the details of the above-described embodiments without departing from the underlying principles presented herein. For example, any suitable combination of various embodiments, or the features thereof, is contemplated.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this Detailed Description are hereby expressly incorporated into this Detailed Description, with each claim standing on its own as a separate embodiment. This disclosure includes all permutations of the independent claims with their dependent claims. Recitation in the claims of the term “first” with respect to a feature or element does not necessarily imply the existence of a second or additional such feature or element. Elements specifically recited in means-plus-function format, if any, are intended to be construed in accordance with 35 U.S.C. §112 ¶6. Embodiments of the invention in which an exclusive property or privilege is claimed are defined as follows.

1. A high throughput screening method for detecting interactions between molecular species, the method comprising:
providing a first solution that comprises a quantity of a first test molecular species;
providing a second solution that comprises a quantity of a target molecular species;
providing a third solution that comprises a quantity of the first test molecular species and a quantity of the target molecular species;
providing a static light scattering detector;
separately measuring light scattering properties of each of the first, second, and third solutions via the static light scattering detector; and
comparing the measured light scattering properties of the third solution to a combination of the measured light scattering properties of the first and second solutions to determine whether the first test molecular species binds with the target molecular species.

2. The method of claim 1, wherein comparing the measured light scattering properties comprises determining a ratio of:
a difference between the measured light scattering properties of the third solution and a combination of the measured light scattering properties of the first and second solutions; and
the combination of the measured light scattering properties of the first and second solutions.

3. The method of claim 1, further comprising determining an excess Rayleigh ratio of each of the first, second, and third solutions, wherein said comparing the measured light scattering properties of the third solution to the measured light scattering properties of the first and second solutions comprises calculating a relative difference between the excess Rayleigh ratio of the third solution and a combination of the excess Rayleigh ratios of the first and second solutions.

4. The method of claim 3, further comprising setting a threshold value against which the relative difference can be compared to determine whether the first test molecular species binds with the target molecular species.

5. The method of claim 4, further comprising comparing the calculated relative difference between the excess Rayleigh ratio of the third solution and the combination of the excess Rayleigh ratios of the first and second solutions to the threshold value.

6. The method of claim 3, further comprising comparing the calculated relative difference to a threshold value to determine whether the first test molecular species binds with the target molecular species.

7. The method of claim 6, wherein, when the first test molecular species binds to the target molecular species within the third solution, a value of the relative difference exceeds the threshold value.

8. The method of claim 1, further comprising:
separately introducing individual aliquots of the first, second, and third solutions into a sample passageway; and
passing a solvent through the sample passageway to separately deliver each of the aliquots to the static light scattering detector for measurement.

9. The method of claim 8, wherein introducing aliquots of the first, second, and third solutions into a sample passageway is performed via an autosampler.

10. The method of claim 1, wherein separately measuring the light scattering properties of the first, second, and third solutions via a static light scattering detector takes place as each solution flows through the static light scattering detector in a substantially continuous manner.

11. The method of claim 10, further comprising integrating measurements of the light scattering properties of each of the first, second, and third solutions, wherein comparing the measured light scattering properties comprises comparing the integrated measurements of the light scattering properties of the third solution to a combination of the integrated measurements of the light scattering properties of the first and second solutions.

12. The method of claim 1, further comprising:
providing a fourth solution that comprises a quantity of a second test molecular species;
providing a fifth solution that comprises a quantity of the second test molecular species and a quantity of the target molecular species;
separately measuring light scattering properties of each of the fourth and fifth solutions via the static light scattering detector; and
comparing the measured light scattering properties of the fifth solution to a combination of the measured light scattering properties of the second and fourth solutions to determine whether the second test molecular species binds with the target molecular species.

13. The method of claim 12, further comprising:
separately introducing individual aliquots of the first, second, third, fourth, and fifth solutions into a sample passageway; and
passing separate quantities of a solvent through the sample passageway to deliver each of the aliquots to the static light scattering detector for measurement,
wherein introducing aliquots of the first, second, third, fourth, and fifth solutions into a sample passageway is performed via an autosampler.

14. The method of claim 1, further comprising separately measuring a concentration of each of the first, second, and third solutions via a concentration detector.

15. The method of claim 1, wherein the static light scattering detector comprises a multi-angle light scattering detector.

16. The method of claim 1, wherein the first and second solutions are substantially equimolar.

17. The method of claim 16, wherein a molar concentration of the first test molecular species in the first solution is about twice the value of a molar concentration of the first test molecular species in the third solution, and wherein a molar concentration of the target molecular species in the second solution is about twice the value of a molar concentration of the target molecular species in the third solution.

18. The method of claim 1, wherein each of the first, second, and third solutions comprises a separate quantity of the same solvent.

19. The method of claim 1, further comprising:
providing an additional solution that comprises a quantity of a test inhibiting molecular species, wherein the third solution further comprises a quantity of the test inhibiting molecular species; and
measuring light scattering properties of the additional solution via a static light scattering detector,
wherein the combination with which the measured light scattering properties of the third solution are compared comprises the measured light scattering properties of the first, second, and additional solutions.

20. A high throughput screening method for detecting interactions between molecular species, the method comprising:
providing a first solution that comprises a quantity of a first test molecular species;
providing a second solution that comprises a quantity of a target molecular species;
providing a third solution that comprises a quantity of the first test molecular species and a quantity of the target molecular species;
separately introducing each of the first, second, and third solutions into a solvent stream;
measuring light scattering properties of the solvent stream via a static light scattering detector, wherein the solvent stream flows through the static light scattering detector substantially continuously during the measuring;
integrating measurements of the light scattering properties of the solvent stream over separate periods during each of which one of the first, second, and third solutions is within a portion of the solvent stream that is being measured via the static light scattering detector; and
comparing the integrated measurements associated with the third solution to a combination of the integrated measurements associated with the first and second solutions to determine whether the first test molecular species binds with the target molecular species.

21-30. (canceled)

31. A high throughput screening method for detecting interactions between molecular species, the method comprising:
providing a first solution that comprises a quantity of a test molecular species;
providing a second solution that comprises a quantity of a target molecular species;
providing a third solution that comprises a quantity of the test molecular species and a quantity of the target molecular species;
separately measuring light scattering properties of each of the first, second, and third solutions via a static light scattering detector;
calculating a relative difference between the third solution and the first and second solutions, wherein the relative difference comprises a ratio of:
a difference between the measured light scattering properties of the third solution and a combination of the measured light scattering properties of the first and second solutions; and
the combination of the measured light scattering properties of the first and second solutions; and
comparing the relative difference to a threshold value to determine whether the test molecular species binds with the target molecular species.

32-34. (canceled)

35. A high throughput screening method for detecting interactions between molecular species, the method comprising:
providing a target solution that comprises a target molecular species;
providing a library of test solutions that includes a first group of test solutions and a corresponding second group of test solutions, wherein each test solution in the first group comprises a different test molecular species, and wherein each test solution in the second group comprises a quantity of one of the different test molecular species and a quantity of the target molecular species;
measuring light scattering properties of the target solution via a static light scattering detector;
separately measuring light scattering properties of each solution in the first group of test solutions via a static light scattering detector;
separately measuring light scattering properties of each solution in the second group of test solutions via a static light scattering detector;
for each test molecular species, comparing the measured light scattering properties of the test solution from the second group with a combination of the measured light scattering properties of the corresponding test solution from the first group and the measured light scattering properties of the target solution to determine whether the test molecular species binds with the target molecular species.

36-46. (canceled)
